(19) United States
(12) Patent Application Publication
(10) Pub. No.: US 2005/0265642 A1
(43) Pub. Date: Dec. 1, 2005

(54) Bearing and method of fabricating the same

(76) Inventors: Kuang-Hsin Liu, Taipei (TW); Chih-Ming Cheng, Taipei (TW)

Correspondence Address: Yi-Wen Tseng, 4331 Stevens Battle Lane, Fairfax, VA, 22033, US

(21) Appl. No.: 10/852,479

(22) Filed: May 25, 2004

(51) Int. Cl. F16C 33/02; F16C 32/06

(52) U.S. Cl. 384/279

(57) ABSTRACT

A bearing used in small or mini-motor axis or driving shaft transmitted by the axis and a method of fabricating the same are disclosed. It is firstly obtaining a ceramic material, sintering the ceramic materials under high temperature to form a fine beads or powders, adding the beads or powders into heat-resisting plastic-steel plastic materials or metal to form a mixture, and molding the mixture to be a bearing by pressing.

### BACKGROUND OF THE INVENTION

The present invention relates to a method of fabricating a bearing and a structure of the bearing. More particularly, the present invention relates to a bearing combines both characters of hard-wear from ceramics as well as tenacity and heat-resistant from plastic-steel materials or metals, and to produce the bearing used for small or mini-motor axis and/or driving shaft transmitted by the axis. The bearing of the present invention not only can absorb the vibration resulted from the high-speed operation of the axis and/or the driving shaft, but also improve the hard-wear of the bearing.

Technology developments make all kinds of products becoming lighter, thinner, shorter, and smaller. In the developments of small and/or mini motors, the rotation rate is seeking gradually for high speed or super-high speed. During the conversion process, the most important component is the developments of bearing system. Among them, high temperature, i.e. abrasion comes from the high rotation rate is the most concerns of the bearing system developments.

Conventional small or mini motor axis or driving shaft transmitted by the axis, such as in an electric drill, pneumatic drill grinding machine, electric screwdriver all take effect in high-sped rotation in aid of bearing. The bearing used in the foregoing machines is constructed by circular or pillar steel balls. The steel balls cannot bear high temperature and must to stop operation when exercising a period of time for scattering the high temperature. Moreover, the bearing made of circular or pillar steel balls often bring the abrasion, make loudly noises, and even get stuck.

To solve the conventional shortcomings, one uses the metallurgy of metal powders to produce the multi-aperture oil bearing, designing a multi-aperture device to restore the lubricant for rotation of small or mini motor axis, then the axis and driving shaft can be lubricant and thereby reduce the friction resistance to make the operation of the axis and/or driving shaft smoother.

However, design of the oil bearing can timely provide axis and/or driving shaft with lubricant, in long-term operation, the bearing composed of pure metal will be worn down because of its weak wear-resisting, shorten the usage of bearing and then effect the quality of related assembly.

Moreover, one example of such method to produce a bearing with mini-motor was disclosed in Taiwan Patent Gazette, publication No. 570101, entitled “Fans”. It disclosed a bearing made of plastic-steel material. The bearing added fiber or stone powders to improve the smooth of interior walls, and make the axis works well, no leakage of oil and solve noises problems. The foregoing design enhances the lubricant of materials in real practice, however, the contact surfaces of bearing will make the axis wear away and even get stuck because of the vary of dimension resulted from the weak heat-resisting of plastic-steel materials.

### BRIEF SUMMARY OF THE INVENTION

The present invention incorporates the wear-resisting ceramic materials as well as heat-resisting and tenacious materials to produce a bearing that can absorb the vibration occurred under high-speed operation comes from the small or mini-motor axis and driving shaft transmitted by the axis. In addition, the present invention is to provide an improved hard-wear of bearing.

The present invention provides a method of fabricating a bearing and a structure of the bearing, which is firstly to obtain a ceramic material, sintering the ceramic materials under high temperature to become fine beads and/or powders, adding the beads and/or powders into heat-resisting plastic-steel materials or metals to form a uniform mixture, and molding the bearing by use of forming press.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The above objects and advantages of the present invention will be become more apparent by describing in detail exemplary embodiments thereof with reference to the attached drawings in which:

FIG. 1 representatively shows a process to fabricate a bearing according to the present invention.

FIG. 2 representatively shows a perspective view of a bearing according to the present invention.

FIG. 3 representatively shows a transverse section view of a bearing according to the present invention.

FIG. 4 representatively shows one preferred embodiment of a bearing according to the present invention.

FIG. 5 representatively shows another preferred embodiment of a bearing according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

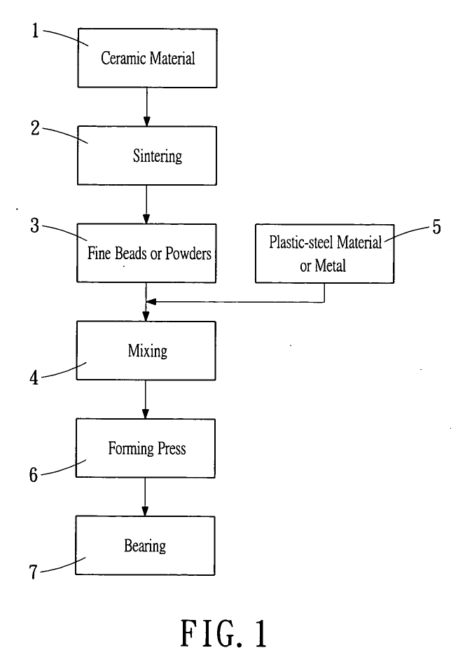

Referring to FIG. 1, it is depicted a process to fabricate the baring of the invention. The method is combining both characters of hard-wearing from ceramics as well as tenacity and heat-resistant from plastic-steel or metal materials to forming the bearing by forming press, and then locating the bearing to the small or mini-motor axis or driving shaft transmitted by the axis. When axis or driving shaft operates, the heat-resisting plastic-steel materials or metal can absorb the energy of vibration, and then enhance the hard-wear of the bearing.

Following steps are for fabricating the bearing of the present invention:
1. Obtaining a ceramic material 1;
2. Sintering 2 the ceramic material under high temperature to become fine beads or powders 3;
3. Combining 4 the beads or powders with the ceramic material and then added into heat-resisting plastic-steel material or metal 5;
4. Proceeding to injection molding after the beads or powders of ceramic material added into the uniform mixture of heating-resisting plastic-steel material or metal molding 6 the bearing by forming press and sintering to complete the fabrication of bearing 7.

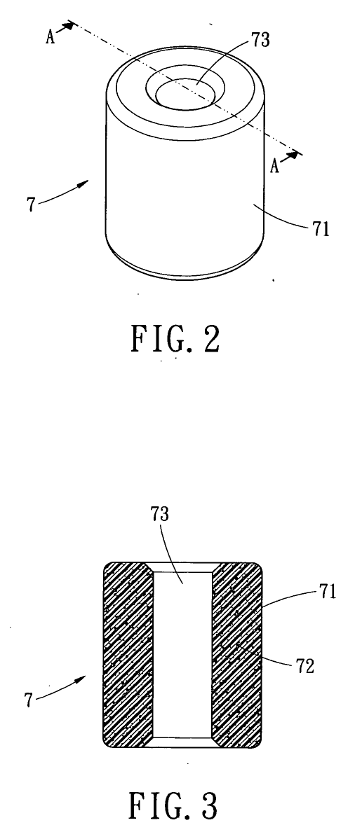

Referring to FIGS. 2 and 3, it is respectively depicted a perspective view of the bearing and a transverse section view taken along A-A of FIG. 2. Reference to the figures, being 7 derived from ceramic material 1 and heat-resisting plastic-steel material or metal 5 are molded by the forming press.

The bearing 7 includes an absorbent body 71 composed of heat-resisting plastic-steel material or metal; a hard-wear portion 72 composed of the beads or powders after the ceramic materials are sintered, wherein the hard-wear portion is enveloped in the absorbent body 71; and a hole 73 passing through the bearing 7 to receive the axis or driving shaft transmitted by the axis. When the driving shaft operates, the absorbent body 71 absorbs the vibration occurred under high speed transmission from axis or driving shaft. Furthermore, the ceramic material can improve the hard-wearing of bearing and increase the usage thereof.

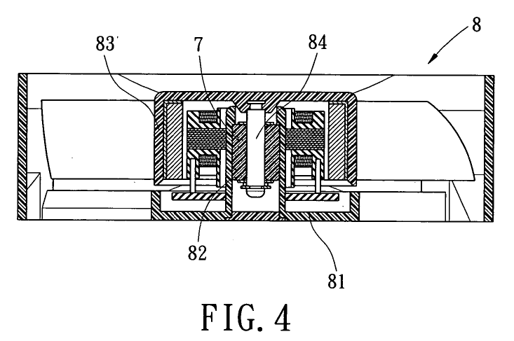

Referring to FIG. 4, it is depicted one exercise condition of the present invention. One embodiment of the present invention illustrated the bearing used in the fans, one sort of mini motor. When using the molded bearing 7, it is mounted on the sheath 82, the sheath is located on the center of base 81 of the fans 8. Axial center 84 of impeller 83 receives the hole 73 of bearing 7, and when the impeller 83 drives, axial center 84 turns in the hole 73 of bearing 7. Under high-speed operation, the absorbent body that is composed of the heat-resisting plastic-steel material or metal can absorb the resulted vibration. In this condition, the axial center 84 can smoothly drive and hard to be damaged, and ceramic material can enhance the hard-wear of bearing 7 and increase the usage of the bearing.

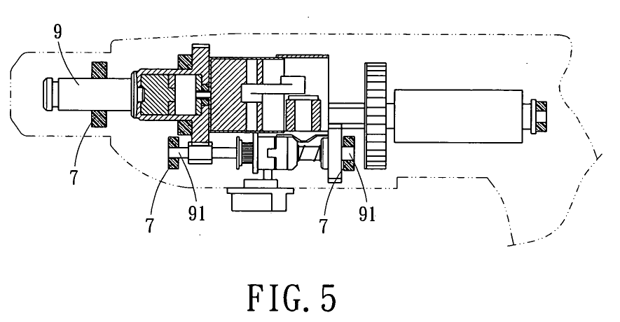

Referring to FIG. 5, it is depicted the exercise condition of another embodiment of the present invention. A driving shaft transmitted by the small motor is illustrated for reference. Current electric drills use the small-motor axis to drive the principal driving shaft 9 and minor driving shaft 91 under high-speed operation. Bearing of the present invention can be used in the principal and minor driving shafts. In this condition, the principal driving shaft 9 and minor driving shaft 91 can smoothly drive and hard to be damaged, the ceramic material can improve the hard-wear of bearing 7 and increase the usage of the bearing.

While the present invention has been particularly shown and described with reference to preferred embodiments thereof, it will be understood by those of ordinary skill in the art the various changes in form and details may be made therein without departing from the spirit and scope of the present invention as defined by the appended clam.

1. A method of fabricating a bearing, comprising the steps of:
obtaining a ceramic material;
sintering the ceramic material in high temperature;
adding the sintered ceramic material into heat-resisting plastic-steel material to form an uniform mixture; and
molding the mixture to the bearing by pressing.

2. The method of claim 1, wherein the sintering step further includes forming the ceramic material into fine beads.

3. The method of claim 1, wherein the sintering step further includes forming the ceramic material into powders.

4. The method of claim 1, wherein the plastic-steel material is heat-resisting and tenacious.

5. A method of fabricating a bearing composed of hard-wearing and tenacious materials to be used in an axis and a driving shaft transmitted by the axis, comprising the steps of:
obtaining a ceramic material;
sintering the ceramic material in high temperature;
adding the sintered ceramic material into heat-resisting plastic-steel metal to form an uniform mixture; and
molding the mixture to the bearing by forming press.

6. A bearing, comprising:
an absorbent body made by heat-resisting plastic-steel material or metal;
a hard-wear portion enveloped in the absorbent body, made by ceramic material; and
a hole passing through the absorbent body and the hard-wear portion to receive an axis or a driving shaft transmitted by the axis,
whereby, when the axis or the driving shaft operate, the absorbent body absorbs a vibration occurred under a high-speed transmission from the axis or the driving shaft, and the ceramic material of the hard-wearing increases the usage of the bearing.
